(19) United States
(12) Patent Application Publication
(10) Pub. No.: US 2016/0240860 A1
(43) Pub. Date: Aug. 18, 2016

(54) NOBLE METAL-FREE CATALYST SYSTEM FOR A FUEL CELL

(71) Applicant: VOLKSWAGEN AG, Wolfsburg (DE)

(72) Inventors: Peter Strasser, Berlin (DE); M. S. Ranjbar, Berlin (DE); Gerold Huebner, Wolfsburg (DE)

(21) Appl. No.: 15/026,549

(22) PCT Filed: Sep. 23, 2014
(86) PCT No.: PCT/EP2014/070275

§ 371 Date: Mar. 31, 2016

(30) Foreign Application Priority Data
Oct. 1, 2013 (DE) 10 2013 219 937.6

(51) Int. Cl. H01M 4/90

(52) U.S. Cl. CPC H01M 4/9008; H01M 4/9083

(57) ABSTRACT

A noble metal-free catalyst system with a carbon-based support material and a polyaniline-metal catalyst bound to the support material is provided. Moreover, fuel cell containing the catalyst system is provided. The polyaniline-metal catalyst -contains iron (Fe) and manganese (Mn).

The invention relates to a noble metal-free catalyst system with a carbon-based support material and a polyaniline-metal catalyst bound to the support material. Moreover, the invention relates to a fuel cell containing said catalyst system.

### BACKGROUND

Electrochemical fuel cells convert the chemical reaction energy obtained from a continuously supplied fuel and from an oxidant into electric energy. For this purpose, the fuel cell has electrodes that are separated from each other by a semi-permeable membrane or by an electrolyte. The electrode plates (also called bipolar plates) usually consist of metal or carbon nanotubes. They are coated with a catalyst such as, for example, platinum or palladium. Examples of possible electrolytes include alkaline solutions or acids, alkali carbonate melts, ceramics or other membranes. The energy stems from a reaction of oxygen with the fuel, for instance, hydrogen or else with organic compounds such as, methane or methanol. In the case of a so-called low-temperature proton exchange membrane fuel cell (PEMFC) or polymer electrolyte fuel cell (PEFC), the bipolar plates, which serve as electrodes, have an incorporated gas passage structure. Moreover, a reactive layer is present that, as a rule, is applied directly onto the ionomer membrane and that contains the catalyst, the electron conductor (usually carbon black or nanomaterials containing carbon) as well as the proton conductor (ionomer). The present invention also relates to polymer electrolyte membrane fuel cells.

A problem that would arise especially in case of widespread use of fuel cell systems in motor vehicles is the high price for the noble metal catalysts platinum or palladium. At the present time, approximately 60 grams of these noble metal(s) are needed per fuel cell stack for a motor vehicle, which currently accounts for material costs amounting to several thousand euros. Even assuming major advances in the coming years, the consumption of platinum or palladium will, at best, be cut in half if a high stability and service life are to be ensured. Consequently, fuel cells will only become competitive in the long term if the costs of the fuel cells come down to the level of conventional internal combustion engines. One approach lies in the provision of noble metal-free catalysts.

U.S. Pat. Appln. No. 2011/0260119 A1 of Los Alamos National Security, LLC, describes a novel iron-cobalt hybrid catalyst that can serve as a replacement for noble metal catalysts in fuel cells. In order to produce the catalyst, first of all, a cobalt complex based on ethylene amine is mixed with an electrically conductive support material containing carbon and, under heating, a catalyst support containing cobalt is obtained. Subsequently, aniline is polymerized in the presence of this support and of a compound containing iron. The catalyst system obtained, which is bound to the support, undergoes a thermal after-treatment and ultimately it yields a catalyst system with an electrically conductive support material based on carbon and a polyaniline-iron/cobalt catalyst that is bound to the support material. Although the activity of the catalyst is comparable to that of the noble metals, it is not stable enough for continuous use in a mobile fuel cell.

U.S. Pat. Appln. No. 2012/0088187 of Los Alamos National Security, LLC, describes a modified production method for a polyaniline-iron/cobalt catalyst. Through a special after-treatment of the catalyst system that can first have been obtained as described above, the activity of the catalytic material can still be increased considerably. For this purpose, the support-bound polyaniline-metal adduct first obtained is heated in an inert atmosphere to temperatures in the range from 400° C. to 1000° C., then washed out with an acid in order to remove unbound metal residues, and subsequently heated once again to 400° C. to 1000° C. in an inert atmosphere.

### SUMMARY OF THE INVENTION

In spite of the considerable progress that has been made in recent years in the development of noble metal-free catalysts for fuel cells, there is an ongoing need for more alternatives, especially for catalyst systems that display better stability.

The present invention provides a catalyst system with a carbon-based support material and a polyaniline-metal catalyst bound to the support material. The polyaniline-metal catalyst is characterized in that it contains iron (Fe) and manganese (Mn).

The invention is based on the realization that a polyaniline-metal catalyst containing iron as well as manganese displays a higher stability than the prior-art polyaniline-metal catalysts. The reasons for this surprising behavior have not yet been fully explained. Even though iron and manganese compete for the active sites of the catalyst system, a process in which iron dominates, at the same time, there seems to be an alloy between the two metal components that makes a major contribution to the stabilization of the catalyst system.

The polyaniline-metal catalyst according to the invention can contain additional metal components, for example, cobalt. Preferably, however, the polyaniline-metal catalyst is a polyaniline-Mn/Fe catalyst, in other words, it contains iron and manganese as the sole metal components.

The molar ratio of manganese to iron is preferably in the range from 1:100 to 100:1, especially 1:5 to 5:1, especially preferably 1:1.5 to 1.5:1, most preferably 1:1. Adherence to the above-mentioned molar ratios of the metal components ensures a stabilization of the catalyst system, along with a still sufficiently high activity. Precisely for fuel cells with an alkaline electrolyte, molar ratios in the range from 1:1.5 to 1.5:1, especially 1:1, are particularly preferred.

Moreover, it is preferable if the metal amounts to a fraction of 10% to 40% by weight of the total weight of the catalyst system. In particular, the fraction amounts to 20% to 30% by weight of the total weight.

Another aspect of the invention relates to a fuel cell, especially to a low-temperature proton exchange membrane fuel cell containing such a catalyst system.

Additional preferred embodiments of the invention ensue from the description below.

### BRIEF DESCRIPTION OF THE DRAWINGS

The invention will be explained below in embodiments, making reference to the accompanying drawings. The following is shown:

FIG. 1 polarization curves of membrane electrode assemblies with a noble metal-free cathode in comparison to a membrane electrode assembly with platinum as the catalyst material of the cathode;

FIG. 2 shows the course of the current density of the membrane electrode assemblies of FIG. 1 over 9000 cycles; and

FIG. 3 shows the mass activity of various catalyst systems at the beginning of the measurement and after 4200 cycles.

### DETAILED DESCRIPTION

The invention is explained in greater detail below with reference to embodiments.

### Synthesis of the Catalyst System

A solution of aniline in 0.5 M HCl was first mixed with a metal precursor, FeCl₃ and/or MnCl₂, and stirred for 30 minutes. Subsequently, under continued agitation, polymerization of the aniline was initiated through the dropwise addition of the oxidant ammonium peroxydisulfate (NH₄)25208 in 0.5 M HCl at 5° C. After the end of the polymerization, which yielded a polymer complex of polyaniline (PANT) and the transition metals Fe/Mn, support materials containing carbon were added in the form of an ultrasonic dispersion in 0.5 M HCl. Various commercially available support materials containing carbon were used, including among others, Vulcan XC-72, Ketjen EC 300J and Ketjen EC600J. Continuous agitation for 24 hours with a reflux at 90° C., removal of the solvent under reduced pressure and drying of the residue under vacuum yielded a uniform product in the form of a polyaniline-metal catalyst bound to the support material containing carbon. This raw product was subsequently thermally treated at 900° C. for 1 hour under an N₂ or NH₃ atmosphere. After the product had cooled off, it was mixed with 2 M H₂SO₄ for 2 hours at 80° C. in order to wash out unbound metal, and subsequently washed with de-ionized water. Then the product was once again heated to 900° C. for 3 hours in an N₂ or NH₃ atmosphere. Some of the product was washed and thermally treated another time with 2 M H₂SO₄, as described above. The metal content in the product was 17.21% and 25% by weight in each case as a function of the molar ratio of the aniline employed and the metal precursor.

Among other things, the following catalyst systems were produced according to this procedure:

Polyaniline-Mn catalyst with 17% by weight of Mn (here also referred to as Mn₁₇-PANI)

Polyaniline-Mn catalyst with 21% by weight of Mn (Mn₂₁-PANI)

Polyaniline-Mn catalyst with 25% by weight of Mn (Mn₂₅-PANI)

Polyaniline-Mn₃Fe catalyst with 25% by weight of Mn+Fe (Mn₃Fe-PANI)

Polyaniline-MnFe catalyst with 25% by weight of Mn+Fe (MnFe-PANI)

Polyaniline-MnFe₃ catalyst with 25% by weight of Mn+Fe (MnFe₃-PANI)

Polyaniline-Fe catalyst with 25% by weight of Fe (Fe-PANI)

### Production of the Catalyst Membrane

The membrane containing the cathode catalyst was produced in a generally known manner by means of an ink-jet printing method. The ink mixture contained 1 gram of the metal-PANI catalyst, 4.4 grams of 2-propanol and 1 gram of Nafion solution (20% solution; a sulfinated tetrafluorethylene polymer) and was freshly made in a ball mill (agitation for 24 hours, zirconium balls). The suspension obtained was applied uniformly onto an ETFE membrane (ETFE=ethylene tetrafluorethylene) using a doctor blade and subsequently dried.

A membrane containing the anode catalyst was produced analogously, whereby a commercially available platinum catalyst was employed as the catalyst and the ink suspension was produced under argon (Pt/C TKK catalyst, 47% by weight, available from the TKK company, Japan). On the anode side as well, polyaniline-metal catalyst systems can be used instead of the platinum catalyst; however, for the sake of better comparability, this was not done.

The obtained membranes containing the anode or cathode catalyst were further processed into a membrane electrode assembly in a known manner, that is to say, they were cut to the requisite electrode dimension and the membranes were hot-pressed (2500 tons, 145° C., 4 minutes) onto an ETFE membrane in order to transfer the catalyst layer from the membranes that served as the support layer. A carbon fiber paper (available from the SGL company, Germany) was used as the gas diffusion layer.

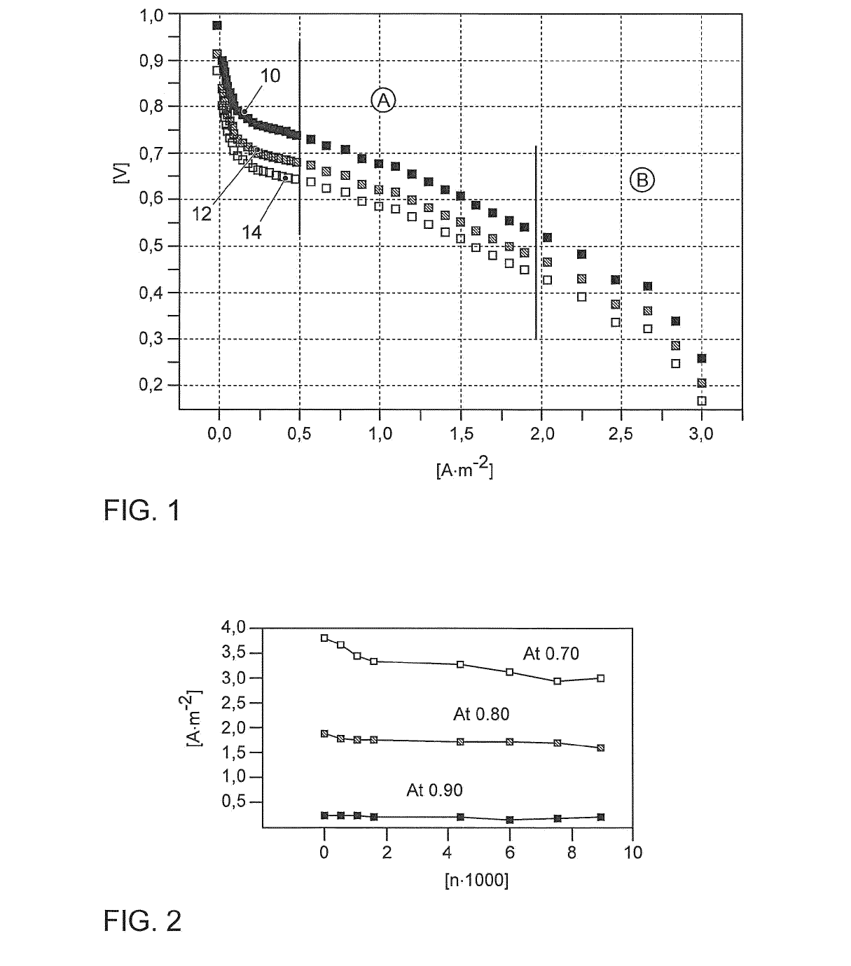

FIG. 1 shows polarization curves of three fuel cells whose membrane electrode assembly was produced as described above. The top curve 10 refers to a fuel cell in which a platinum catalyst was used cathodically as well as anodically (Pt/C TKK catalyst on Ketjen 600). Curve 12 depicts the behavior of a fuel cell that contains Fe-PANI (on Ketjen 600) as the cathode catalyst. Finally, curve 14 shows the behavior of a fuel cell with the cathode catalyst Mn₂₅-PANI (likewise on Ketjen 600). The letter A refers to the ohmic range and the letter B refers to the range of the mass transport.

As can be seen, the output of the fuel cell with the cathode containing manganese is only about 20% less than the output in a conventional fuel cell with a cathode platinum catalyst. Accordingly, the use of polyaniline-manganese catalysts constitutes another alternative for noble metal-free fuel cells. The output of a catalyst system based solely on manganese, however, falls below the output of the prior-art catalyst system based on iron. However, the fuel cell with the polyaniline-manganese catalyst displayed a significant improvement of the operational stability and exhibited a maximum drop in output of only 20% over 8000 cycles, measured at potentials of 0.7 V, 0.8 V, and 0.9 V in 0.1 M HClO₄ at a pulse rate of 50 μs (see FIG. 2).

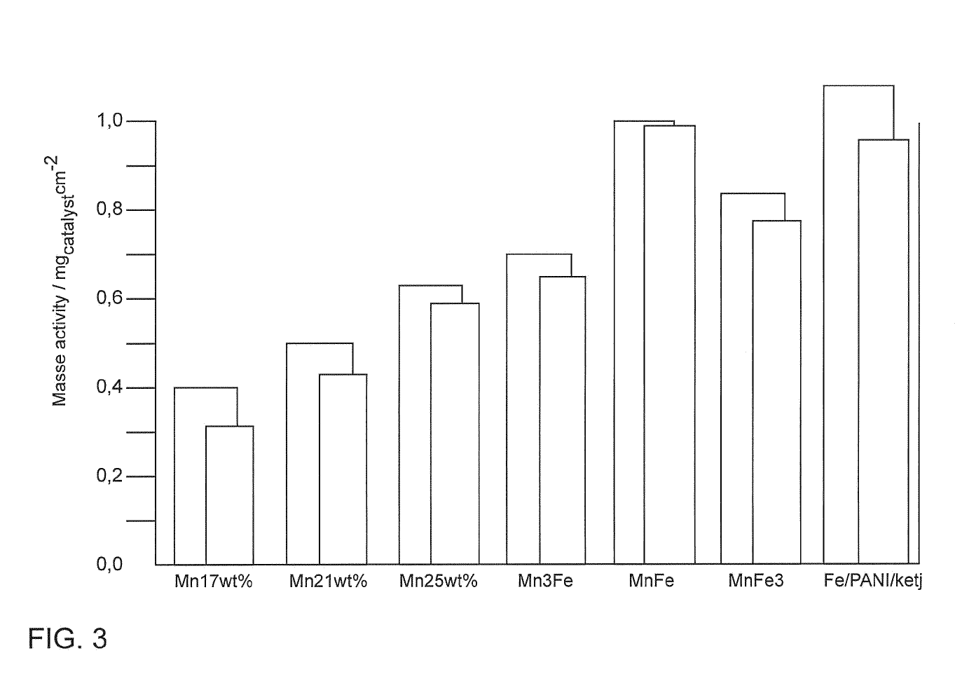

The mass activities of various catalyst systems at the beginning of each measurement as well as after 4200 cycles can be found in the bar diagram of FIG. 3. The left-hand column in the background depicts the mass activity at the beginning of the measurement while the right-hand column in the foreground depicts the mass activity after 4200 cycles. As can be seen here, the mass activity of a fuel cell with the prior-art Fe-PANI catalyst on the cathode side is high at the beginning of the measurement, but it declines sharply already after 4200 cycles because of the lower stability of the catalyst. At the beginning of the measurement, the mass activity of the fuel cell with the catalysts solely containing manganese is much lower in comparison to the prior-art iron catalyst. However, the output drop after 4200 cycles is also lower. It was surprisingly found that catalysts containing manganese as well as iron displayed a much lower drop in mass activity after 4200 cycles as well as already a relatively high mass activity at the beginning of the measurement. The best result was achieved with a cathode catalyst in which iron and manganese were present in equimolar quantities.

Moreover, initial measurements were carried out in alkaline fuel cells that contained MnFe-PANI, Mn₃Fe-PANI or MnFe₃-PANI as the cathode catalyst. The mass activity of these fuel cells already at the beginning of the measurements was comparable to the mass activity of a fuel cell with the less stable Fe-PANI. Consequently, the polyaniline-Mn/Fe catalyst systems provided according to the invention are also suitable for use in alkaline membrane fuel cells.

### List of Reference Numerals

10 polarization curve of a membrane electrode assembly with a Pt catalyst

12 polarization curve of a membrane electrode assembly with an Fe-PANI catalyst

14 polarization curve of a membrane electrode assembly with an Mn-PANI catalyst

1-8 (canceled)

9. A catalyst system comprising:
a carbon-based support material; and
a polyaniline-metal catalyst bound to the support material, the polyaniline-metal catalyst including iron (Fe) and manganese (Mn).

10. The catalyst system as recited in claim 9 wherein the polyaniline-metal catalyst is a polyaniline-Mn/Fe catalyst.

11. The catalyst system as recited in claim 9 wherein a molar ratio of Mn to Fe is in the range from 1:100 to 100:1.

12. The catalyst system as recited in claim 11 wherein the molar ratio of Mn to Fe is in the range from 1:5 to 5:1.

13. The catalyst system as recited in claim 12 wherein the molar ratio of Mn to Fe is in the range from 1:1.5 to 1.5:1.

14. The catalyst system as recited in claim 13 wherein molar ratio of Mn to Fe is 1:1.

15. The catalyst system as recited in claim 9 wherein metal amounts to a fraction of 10% to 40% by weight of the total weight of the catalyst system.

16. A fuel cell comprising the catalyst system as recited in claim 9.
